(19) United States
(12) Patent Application Publication
(10) Pub. No.: US 2021/0046898 A1
(43) Pub. Date: Feb. 18, 2021

(54) Vehicle Occupancy Detection and Notification System

(71) Applicants: Van Walker, Kenner, LA (US); Whitney Walker, Kenner, LA (US)

(72) Inventors: Van Walker, Kenner, LA (US); Whitney Walker, Kenner, LA (US)

(21) Appl. No.: 16/995,304

(22) Filed: Aug. 17, 2020

Related U.S. Application Data
(60) Provisional application No. 62/887,310, filed on Aug. 15, 2019.

(51) Int. Cl. B60R 25/10; G06K 9/00; H04N 5/28; G08B 13/196

(52) U.S. Cl. CPC B60R 25/10; G06K 9/00255; H04W 4/48; G06K 9/00838; G08B 13/19647; H04N 5/28

(57) ABSTRACT

A vehicle occupancy detection and notification system is provided for integration upon a targeted area. The system includes a camera and a sensor. The camera and the sensor are in operable connection with a processor programmed with a presence detection protocol. The presence detection protocol is designed to detect the presence of an occupant within the targeted area. A wireless signal transceiver is also operably connected to the processor. The wireless signal transceiver is designed to transmit signals to a device equipped with a wireless signal receiver.

### CROSS REFERENCE TO RELATED APPLICATIONS

This application claims the benefit of U.S. Provisional Application No. 62/887,310 filed on Aug. 15, 2019. The above identified patent application is herein incorporated by reference in its entirety to provide continuity of disclosure.

### BACKGROUND OF THE INVENTION

The present invention relates to a vehicle occupancy detection and notification system. More specifically, the present system relates to an integrated apparatus for detecting an individual within a targeted area and notifying a secondary individual outside of the targeted area.

When individuals become distracted or are in a hurry, tragedies too often occur as children are forgotten or otherwise left in unattended vehicles. When children are left in vehicles while they are exposed to high or low temperatures, serious medical risks, including heat stroke, hypothermia, or death may occur. In addition to parents or relative caretakers, bus drivers are also charged with the safety of children. For bus drivers, it can be difficult to keep track of a large number of children.

Additionally, when people leave valuables or expensive possessions in their vehicles while they are unattended, these items may attract thieves. When thieves break into vehicles to steal valuables, they not only take the value of the stolen possessions away from the vehicle owner, but they also can cause damage by breaking windows or locks. Since these types of crimes can occur at night or in unmonitored areas, it is not common for these criminals to be identified.

Therefore, there is a defined need amongst the known art for a versatile system of notifying vehicle owners, of the presence of an individual, such as a child or a thief, if such an individual is left in an automobile or enters the automobile once the automobile is turned off.

### SUMMARY OF THE INVENTION

In view of the foregoing disadvantages inherent in the known types of occupancy detection and alert systems now present in the prior art, the present invention provides a vehicle occupancy detection and notification system wherein the same can be utilized for providing convenience for the user when alerting them to the presence of an individual in a targeted area.

The present system comprises a camera. The camera is configured to capture photographic and videographic data. Furthermore, the camera is in operable connection with a processor. The system further comprises at least one sensor. The sensor is configured to detect the presence of an occupant within a targeted area. The sensor is in operable connection with the processor. The processor comprises a presence detection protocol. The presence detection protocol is engaged upon the detection of an occupant within a targeted area, such as a vehicle. A wireless signal transceiver is in operable connection with the processor. The wireless signal transceiver is configured to release a wireless signal when an alert is generated by the processor.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the vehicle occupancy detection and notification system.

FIG. 2 shows a perspective view of a housing of an embodiment of the vehicle occupancy detection and notification system.

FIG. 3 shows a demonstrative view of an embodiment of the vehicle occupancy detection and notification system.

### DETAILED DESCRIPTION OF THE INVENTION

Reference is made herein to the attached drawings. Like reference numerals are used throughout the drawings to depict like or similar elements of the vehicle occupancy detection and notification system. The figures are intended for representative purposes only and should not be considered to be limiting in any respect.

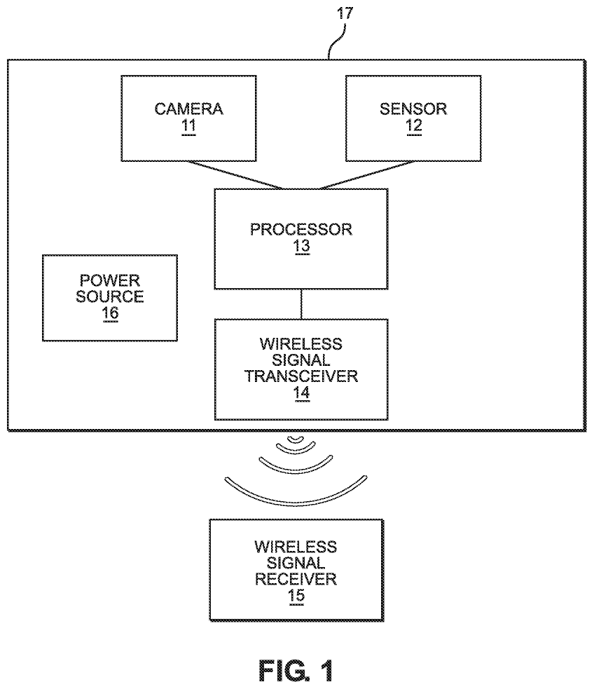

Referring now to FIG. 1, there is shown a block diagram of an embodiment of the vehicle occupancy detection and notification system. The vehicle occupancy detection and notification system comprises a camera 11. The camera 11 is configured to capture photographic and videographic data and is of any suitable configuration for such purpose. In one embodiment, the camera 11 comprises a charge-coupled device. As such, a digitized image may be rendered by the camera 11.

The vehicle occupancy detection and notification system further comprises at least one sensor 12. The sensor 12 is configured to detect the presence of an occupant within a targeted area. The sensor 12 is of any suitable configuration for detecting the presence of an individual. For example, at least one sensor 12 may comprise an infrared sensor, such as to detect the presence of an individual utilizing a plurality of infrared beams. Additionally, at least one sensor 12 may comprise an audio sensor, such as to detect the presence of an individual by sensing noise generated by an individual in the targeted area. In a further embodiment, at least one sensor 12 may comprise a motion sensor, such as to detect motions of an individual located within the targeted area. Additionally, in some embodiments, at least one sensor 12 may comprise a temperature sensor, such as to detect temperature signatures within the targeted area.

The camera 11 and the sensor 12 are in operable connection with a processor 13. The processor 13 comprises a presence detection protocol. The presence detection protocol is engaged upon the detection of an occupant within the targeted area. The processor 13 is of any suitable configuration for receiving and analyzing visual data and sensory data gathered by the camera 11 and the sensors 12, respectively. The presence protection protocol may utilize any known form of identification. For example, in one embodiment, the processor 13 may utilize a facial recognition protocol to determine the presence of an individual in the targeted area. The camera 11 may comprise a microphone to collect audio data.

Additionally, the vehicle occupancy detection and notification system further comprises a wireless signal transceiver 14. The wireless signal transceiver 14 is in operable connection with the processor 13. As such, the wireless signal transceiver 14 is configured to release or transmit a wireless signal when an alert is generated by the processor 13. In one embodiment, the processor 13 and the wireless signal transceiver 14 are programmed to create a video and audio stream, recorded by the camera 11, that is broadcasted by the wireless signal transceiver 14 and accessible by a remote device, such as a mobile phone or tablet.

In the illustrated embodiment, the vehicle occupancy detection and notification system comprises a wireless signal receiver 15. The wireless signal receiver 15 is configured to receive the wireless signal emitted from the wireless signal transceiver 14 when the alert is generated by the processor 13. In one embodiment, the wireless signal receiver 15 comprises a stand-alone unit, such as a key fob or tag. In another embodiment, the wireless signal receiver 15 comprises a multi-functional device, such as a mobile phone.

The vehicle occupancy detection and notification system comprises a power source 16. The power source 16 is operably connected to the camera 11, the sensor 12, the processor 13 and the wireless signal transceiver 14. Furthermore, the power source 16 is of any suitable configuration for providing usable power to the connected components. For example, the power source 16 may be a stand-alone power system, such as a battery. Alternatively, the power source 16 may comprise the power system of a vehicle upon which the vehicle occupancy detection and notification system is installed. In some embodiments, the processor 13 may be configured to activate the vehicle occupancy detection and notification system when the vehicle engine of a vehicle on which the system is installed is turned off.

In the demonstrated embodiment, the camera 11, the sensor 12, the processor 13, the wireless signal transceiver 14, and the power source 16 are disposed within the targeted area 17. In some embodiments, the camera 11, the sensor 12, the processor 13 and the wireless signal transceiver 14 are in operable connection via an electrical wiring system. In alternate embodiments, the camera 11, the sensor 12, the processor 13 and the wireless signal transceiver 14 are operably connected via a wireless connection to the local network.

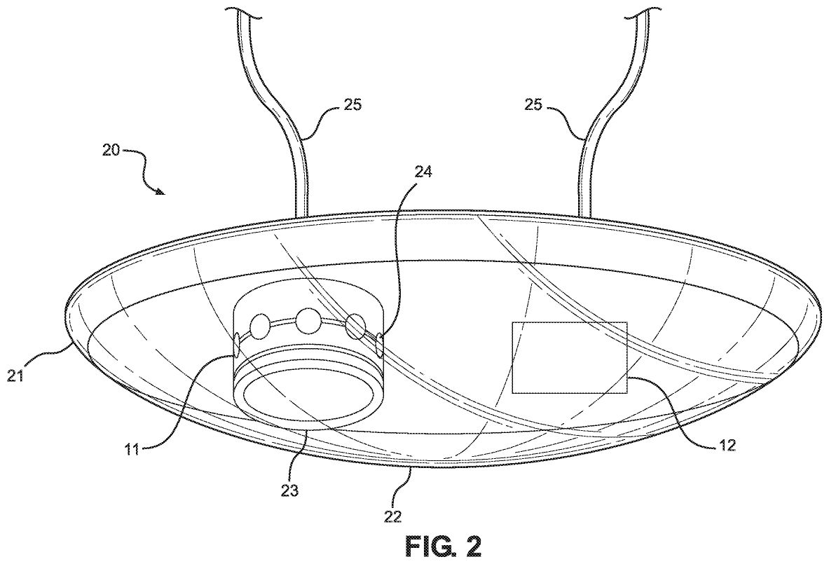

Referring now to FIG. 2, there is shown a perspective view of a housing of an embodiment of the vehicle occupancy detection and notification system. In the illustrated embodiment, the vehicle occupancy detection and notification system comprises a housing 20. The housing 20 is configured to provide protection to the components of the vehicle occupancy detection and notification system. Structurally, the housing 20 comprises a base 21 with a protective cover 22 extending thereover. The housing 20 forms an interior volume between the base 21 and the protective cover 22. In the shown embodiment, the camera 11 is disposed in the interior volume between the base 21 and the protective cover 22 of the housing 20. Additionally, a sensor 12 is disposed in the interior volume of the housing 20. In alternate embodiments, additional cameras or sensors may be disposed externally of the housing 20, or in a separate housing. In the illustrated embodiment, a plurality of wires 25 feed into the housing 20, such as to supply power to the components within the housing 20.

Furthermore, in the demonstrated embodiment, the camera 11 comprises at least one light 24 in operable connection with the camera 11. In the shown embodiment, the plurality of lights 24 extend around the circumference of the camera 11 adjacent to a lens 23 of the camera 11. As such, the camera 11 will be able to record images and video in the absence of light. The plurality of lights 24 are of and suitable configuration for providing directional light. For example, the plurality of lights 24 may comprise a plurality of light-emitting diodes.

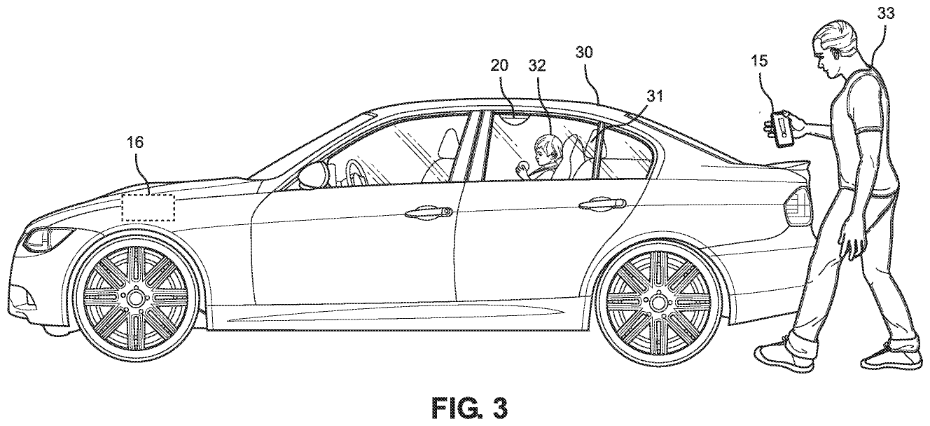

Referring now to FIG. 3, there is shown a demonstrative view of an embodiment of the vehicle occupancy detection and notification system. In the illustrated embodiment, the vehicle occupancy detection and notification system is installed on an automobile 30. Specifically, in the shown embodiment, a housing 20 is centrally installed on the ceiling of a sedan. In alternate embodiments, the housing 20 is placed between rows of seats to define a larger targeted area, such as the passenger compartment of a van or a sports utility vehicle. The housing 20 is ideally placed such that a child 32 placed in the passenger compartment 31 of the vehicle 30 is within the targeted area. Furthermore, in the illustrated embodiment, the power source 16 is the electrical system of the automobile 30.

In use, the camera and at least one sensor will transmit visual and sensory data to the processor from the targeted area defined by the placement of the housing 20. The processor, utilizing the presence detection protocol, will identify the presence of an individual (such as a child 32) within the targeted area (such as the passenger compartment 31 of the automobile 30). An alert is transmitted by the processor, through the wireless signal transceiver, once the presence of an individual is detected. The alert is transmitted to the wireless signal receiver 15. In the illustrated embodiment, the wireless signal receiver 15 is a mobile phone in possession of the user 33. Once the user 33 receives the alert, they will be notified of the presence of the individual in the targeted area.

In some embodiments, the processor is in operable connection with a timer. In such an embodiment, the processor comprises a snooze protocol. The snooze protocol is defined wherein an alert generated by the processor may be dismissed, or postponed, for a temporary amount of time, as determined by the timer. The processor may further be programmed to enact an emergency services protocol, wherein emergency services are notified of the alert and summoned to the location via the vehicle's GPS location device after a threshold amount of time, determined by the timer.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle occupancy detection and notification system, comprising:
a camera;
the camera configured to capture photographic data, videographic data, audio data, and video recording data;
the camera in operable connection with a processor;
at least one sensor;
the sensor configured to detect the presence of an occupant within a targeted area;
the sensor in operable connection with the processor;
the processor comprising a presence detection protocol;
wherein the presence detection protocol is engaged upon the detection of an occupant within a targeted area;
a wireless signal transceiver in operable connection with the processor;
the wireless signal transceiver configured to release a wireless signal when an alert is generated by the processor.

2) The vehicle occupancy detection and notification system of claim 1, wherein at least one sensor comprises an infrared sensor.

3) The vehicle occupancy detection and notification system of claim 1, wherein at least one sensor comprises an audio sensor.

4) The vehicle occupancy detection and notification system of claim 1, wherein at least one sensor comprises a motion sensor.

5) The vehicle occupancy detection and notification system of claim 1, wherein at least one sensor comprises a temperature sensor.

6) The vehicle occupancy detection and notification system of claim 1, further comprising a wireless signal receiver, configured to receive the wireless signal from the wireless signal transceiver.

7) The vehicle occupancy detection and notification system of claim 6, wherein the wireless signal receiver comprises a stand-alone unit.

8) The vehicle occupancy detection and notification system of claim 6, wherein the wireless signal receiver comprises a multi-functional device.

9) The vehicle occupancy detection and notification system of claim 1, wherein the processor and the wireless signal transceiver are programmed to create and stream a video broadcast that is accessible by a remote device.

10) The wireless occupancy detection and notification system of claim 1, further comprising a housing, the housing defined by a base with a protective cover extending thereover, forming an interior volume.

11) The vehicle occupancy detection and notification system of claim 1, wherein the camera, the sensor, the processor, and the wireless signal transceiver are in operable connection via an electrical wiring system.

12) The vehicle occupancy detection and notification system of claim 1, wherein the camera further comprises a charge-coupled device.

13) The vehicle occupancy detection and notification system of claim 1, wherein the camera is in operable connection with a light.

14) The vehicle occupancy detection and notification system of claim 1, wherein the system is in operable connection with the power source of a vehicle on which the system is installed.

15) The vehicle occupancy detection and notification system of claim 1, wherein the processor is in operable connection with a timer.

16) The vehicle occupancy detection and notification system of claim 15, wherein the processor comprises a snooze protocol, wherein a notification may be dismissed for a temporary amount of time determined by the timer.

17) The vehicle occupancy detection and notification system of claim 15, wherein an emergency services protocol is enacted upon a time threshold being surpassed, wherein emergency services are notified of the alert.

18) The vehicle occupancy detection and notification system of claim 1, wherein the presence detection protocol comprises a facial recognition protocol.
